(19) United States
(12) Patent Application Publication
(10) Pub. No.: US 2025/0033433 A1
(43) Pub. Date: Jan. 30, 2025

(54) LOW PRESSURE DROP MUFFLER

(71) Applicant: Hanon Systems, Daejeon (KR)

(72) Inventors: Anthony Charles Arruda, III, Ann Arbor, MI (US); Eric Kesler, Northville, MI (US); Dan Ratkos, Warren, MI (US)

(21) Appl. No.: 18/359,402

(22) Filed: Jul. 26, 2023

(51) Int. Cl. B60H 1/00

(52) U.S. Cl. CPC B60H 1/00571; B60H 2001/006

(57) ABSTRACT

A flow control insert configured for installation into a muffler housing includes a tubular insert circumferential wall having an insert inner circumferential surface defining a flow pathway extending axially across at least a portion of an expansion chamber of the muffler housing. An inner diameter of the insert inner circumferential surface is less than an inner diameter of the at least a portion of the expansion chamber and the insert inner circumferential surface delimits radially outward expansion of the fluid when the fluid is passing through the flow pathway along the at least a portion of the expansion chamber. At least a section of the insert circumferential wall disposed along the expansion chamber is porous to provide acoustic wave communication between the flow pathway and a housing inner circumferential surface of the muffler housing along the at least a portion of the expansion chamber.

### FIELD OF THE INVENTION

The invention relates to a refrigerant circuit having a refrigerant muffler incorporated therein as a noise attenuation device, and more particularly, a refrigerant muffler having a flow control insert incorporated therein for controlling a flow of refrigerant through the refrigerant muffler in a manner reducing a pressure drop experienced by a refrigerant passing through the refrigerant muffler.

### BACKGROUND

Vehicular air-conditioning systems commonly employ a compressor to circulate a refrigerant through various components of a corresponding refrigerant circuit. Such compressors tend to operate in a cyclical manner wherein the refrigerant repeatedly exits the compressor as pulses of relatively high-pressure refrigerant. These pulses of high-pressure flow can result in relatively inconsistent flow of the refrigerant through the refrigerant circuit components as well as the generation of noise that can propagate throughout such refrigerant circuit components. This noise can be undesirable to the passengers of a vehicle having such an air-conditioning system incorporated therein.

To mitigate compressor noise and to smooth out the flow of refrigerant, mufflers have been utilized in refrigerant circuits at a position immediately upstream or immediately downstream of the corresponding compressor where the refrigerant is gaseous in phase. Conventional refrigerant mufflers typically consist of a housing with an inlet and an outlet, with an expansion chamber having an increased flow cross-section located between the inlet and outlet. The expansion chamber, the inlet, and the outlet are provided in a specific configuration wherein acoustic waves of a specific range of frequencies are able to reflect at an outlet end of the expansion chamber to interfere with new acoustic waves entering the expansion chamber at the inlet end thereof, thereby attenuating acoustic waves of certain preselected frequencies. However, the existing refrigerant muffler designs often suffer from a significant drawback-they cause excessive pressure drops in the refrigerant flow, which can negatively impact the overall performance of the refrigeration circuit.

For example, FIG. 1 illustrates the general manner of operation of a substantially generic refrigerant muffler 1 according to the prior art. The refrigerant muffler 1 includes a two-part housing that defines an expansion chamber 2, an inlet 3 into the expansion chamber 2, and an outlet 4 from the expansion chamber 2, wherein the inlet 3 and the outlet 4 have reduced inner diameters in comparison to the enlarged expansion chamber 2. The expansion chamber 2 allows for acoustic waves 5 to expand therein in a manner wherein the acoustic waves can reflect back from a rear surface of the expansion chamber 2 adjacent the outlet 4 for destructive interference with new acoustic waves entering the expansion chamber 2 at the inlet 3 thereof. However, the configuration of the refrigerant muffler 1 undesirably results in the refrigerant flowing therethrough being subjected to an especially rapid period of radial outward expansion and then radial inward contraction when passing from the inlet 3 to the outlet 4 via the expansion chamber 2, which facilitates a drop in pressure of the refrigerant. As shown in FIG. 1, it has also been discovered that recirculation zones 6 of the refrigerant that form around the inlet 3 and the outlet 4 further exacerbate this effect, as the expansion of the refrigerant and then subsequent expansion is restricted to an even smaller axial length of the refrigerant muffler 1 via the flow configuration of the refrigerant around each of the recirculation zones 6.

The excessive pressure drop caused by the configuration of the conventional refrigerant muffler of FIG. 1 can lead to decreased system efficiency, increased power consumption, and compromised cooling capacity of the corresponding air-conditioning system. Additionally, it can cause imbalances in the refrigerant flow rate throughout the system, resulting in reduced overall system performance.

Therefore, there is a need for an improved refrigerant muffler that effectively suppresses noise generated by the compressor while minimizing the pressure drop experienced by the refrigerant flow. Such a design would enable the corresponding refrigeration system to maintain its efficiency, cooling capacity, and overall performance.

### SUMMARY OF THE INVENTION

In accordance with the present disclosure, a flow control insert for installation into a muffler housing has surprisingly been discovered.

According to an embodiment of the present invention, a flow control insert configured for installation into a muffler housing receiving a flow of a fluid therethrough is disclosed. The muffler housing includes an expansion chamber formed therein with the expansion chamber defined by a housing inner circumferential surface of the muffler housing. The flow control insert includes a tubular insert circumferential wall having an insert inner circumferential surface defining a flow pathway through the flow control insert from a first end to a second of the insert circumferential wall with respect to an axial direction thereof. The flow pathway extends axially across at least a portion of the expansion chamber of the muffler housing when the flow control insert is installed therein. An inner diameter of the insert inner circumferential surface is less than an inner diameter of the at least a portion of the expansion chamber. The insert inner circumferential surface delimits radially outward expansion of the fluid when the fluid is passing through the flow pathway along the at least a portion of the expansion chamber. At least a section of the insert circumferential wall disposed along the expansion chamber is porous to provide acoustic wave communication between the flow pathway and the housing inner circumferential surface along the at least a portion of the expansion chamber.

According to another embodiment of the invention, a refrigerant muffler configured to convey a flow of refrigerant therethrough includes a muffler housing having a housing inner circumferential surface defining an expansion chamber, an inlet into the expansion chamber, and an outlet from the expansion chamber, and a flow control insert disposed within the muffler housing. The flow control insert includes a tubular insert circumferential wall having an insert inner circumferential surface defining a flow pathway through the flow control insert from a first end to a second of the insert circumferential wall with respect to an axial direction thereof. The flow pathway extends axially across at least a portion of the expansion chamber of the muffler housing when the flow control insert is installed therein. An inner diameter of the insert inner circumferential surface is less than an inner diameter of the at least a portion of the expansion chamber. The insert inner circumferential surface delimits radially outward expansion of the refrigerant when the refrigerant is passing through the flow pathway along the at least a portion of the expansion chamber in a direction from the inlet to the outlet of the expansion chamber. At least a section of the insert circumferential wall disposed along the expansion chamber is porous to provide acoustic wave communication between the flow pathway and the housing inner circumferential surface along the at least a portion of the expansion chamber.

### BRIEF DESCRIPTION OF THE DRAWINGS

FIG. 1 is an elevational cross-sectional view through a central plane of a refrigerant muffler having an expansion chamber according to the prior art;

FIG. 2 is a schematic view of a refrigerant circuit having a refrigerant muffler according to an embodiment of the present invention incorporated therein;

FIG. 3 is an elevational cross-sectional view through a central plane of the refrigerant muffler of FIG. 2, wherein the refrigerant muffler includes a flow control insert disposed within a muffler housing;

FIG. 4 is an elevational cross-sectional view of the flow control insert of the refrigerant muffler of FIG. 3 in isolation;

FIG. 5 is an elevational cross-sectional view through a central plane of the refrigerant muffler having a modified housing configuration according to another embodiment of the present invention;

FIG. 6 is an elevational cross-sectional view through a central plane of a refrigerant muffler having a modified flow control insert according to another embodiment of the present invention, wherein the flow control insert includes the formation of a Venturi passageway therein;

FIG. 7 is an elevational cross-sectional view through a central plane of a refrigerant muffler according to another embodiment of the present invention, wherein the refrigerant muffler includes a flow control insert formed exclusively from a porous material;

FIG. 8 is an elevational cross-sectional view through a central plane of a refrigerant muffler according to another embodiment of the present invention, wherein the refrigerant muffler includes a flow control insert having centering discs surrounding a circumferential wall;

FIG. 9 is an elevational cross-sectional view through a central plane of a refrigerant muffler according to another embodiment of the present invention, wherein the refrigerant muffler includes a flow control insert formed by an axial stack of porous disc elements;

FIG. 10 is an elevational cross-sectional view through a central plane of a refrigerant muffler according to another embodiment of the present invention, wherein the refrigerant muffler includes a flow control insert formed by a combination of a circumferential wall surrounded by a stack of porous disc elements;

FIG. 11 is an elevational cross-sectional view through a central plane of a refrigerant muffler according to another embodiment of the present invention, wherein the refrigerant muffler includes a flow control insert having a flow pathway with an enlarged inner diameter; and

FIG. 12 is a line graph comparing the pressure drop experienced by a refrigerant when passing through either of two different refrigerant muffler assemblies, including an embodiment of the present invention, to a straight cylindrical pipe at different flow rates of the refrigerant.

### DETAILED DESCRIPTION OF THE INVENTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

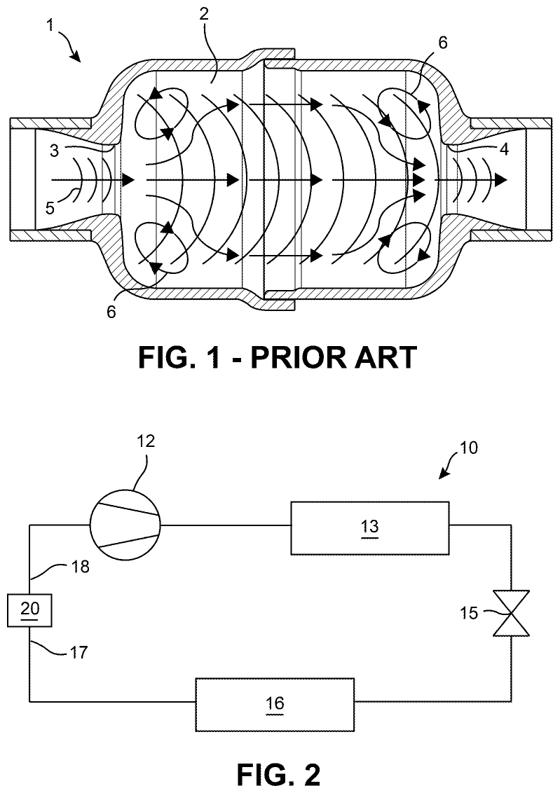

FIG. 1 schematically illustrates a refrigerant circuit 10 having a refrigerant muffler 20 according to an embodiment of the present invention installed thereon. The refrigerant circuit 10 may be incorporated in a vehicle, such as a hybrid or electric vehicle, relying upon stored electrical power to provide heat to various components of the vehicle and/or air to be delivered to the passenger cabin of the vehicle via the operation of the refrigerant circuit 10. However, the present invention may be utilized in any refrigerant circuit utilized for any application without necessarily departing from the scope of the present invention.

The refrigerant circuit 10 includes, in an order of flow of a refrigerant during a heat pump mode of operation, a compressor 12, a condenser/gas cooler 13, an expansion element 15, an evaporator/chiller 16, and the refrigerant muffler 20. The refrigerant circuit 10, as illustrated, is simplified in form and may include any additional components or alternative flow paths associated with varying the mode of operation of the refrigerant circuit 10 while remaining within the scope of the present invention. The refrigerant muffler 20 is disclosed as being disposed immediately upstream of the compressor 12 to receive a flow of relatively low-pressure, gaseous refrigerant prior to the refrigerant entering a low-pressure side of the compressor 12. The refrigerant muffler 20 may accordingly be provided at the disclosed position to ensure that the refrigerant does not experience an undesirably large drop in pressure prior to entry into the low-pressure side of the compressor 12. However, the refrigerant muffler 20 may alternatively be positioned downstream of the compressor 12 in order to receive a high-pressure, gaseous form of the refrigerant prior to the refrigerant passing through any of the basic components 13, 15, 16 of the refrigerant circuit 10 without departing from the scope of the present disclosure.

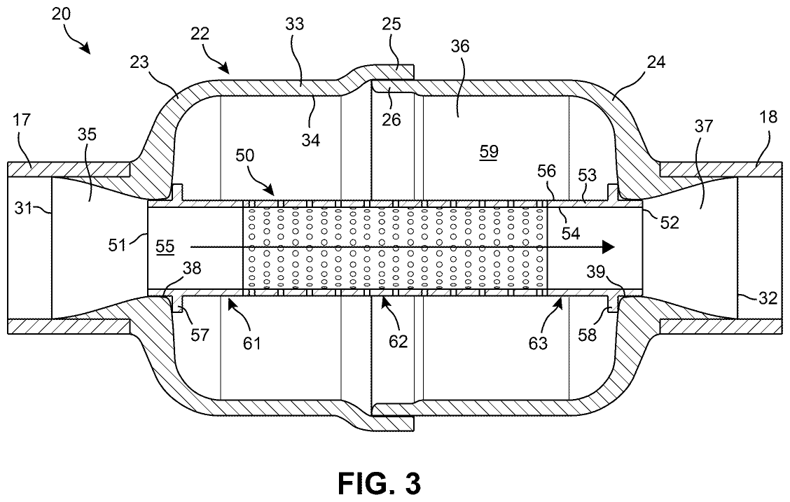

As shown in FIG. 3, the refrigerant muffler 20 according to the present invention includes a muffler housing 22 and a flow control insert 50 disposed within the muffler housing 22. As explained in detail hereinafter, a configuration of the muffler housing 22 is selected in order to attenuate certain frequencies of acoustic waves passing through the refrigerant muffler 20 while the flow control insert 50 is provided to control a flow of the refrigerant through the refrigerant muffler 20 in a manner reducing a pressure drop of the refrigerant when passing therethrough. The refrigerant muffler 20 of the present invention is characterized by the manner in which the flow control insert 50 is selected to not have an appreciable effect on the acoustic wave attenuation provided by the muffler housing 22 of the refrigerant muffler 20, but exclusively aids in controlling the flow of the refrigerant through the refrigerant muffler 20 for minimizing the pressure drop experienced by the refrigerant.

The muffler housing 22 of the present invention is comprised of an assembly of a first housing segment 23 and a second housing segment 24. Each of the housing segments 23, 24 may be formed from a rigid metallic material, such as aluminum. Each of the housing segments 23, 24 includes a substantially axially symmetric configuration relative to a central axis of the muffler housing 22 to result in each of the housing segments 23, 24 being comprised of substantially cylindrical and/or conical surfaces for establishing the desired acoustic wave attenuating feature of the muffler housing 22. In the present embodiment, the first housing segment 23 includes a radially outwardly flared first end section 25 configured to receive a cylindrical second end section 26 of the second housing segment 24 therein when assembling the first and second housing segments 23, 24 into the configuration of the fully assembled muffler housing 22. That is, an inner circumferential surface of the first housing segment 23 is flared radially outwardly along the first end section 25 to include an inner diameter corresponding to an outer diameter of the second housing segment 24 at the second end section 26 to slidably receive the second end section 26 axially into the first end section 25. The first end section 25 forms an open end of the first housing segment 23 and the second end section 26 forms an open end of the second housing segment 24 such that the refrigerant passing through the muffler housing 22 can pass across the seam formed between the housing segments 23, 24 when coupled to one another according to the configuration of FIG. 3.

However, in other embodiments, the first and second end sections 25, 26 may be provided to include the same inner diameters to cause the axial end surfaces of the end sections 25, 26 to abut each other at the seam formed between the housing segments 23, 24, so long as the resulting configuration of the muffler housing 20 has the desired sound attenuating capabilities. Regardless of the type of joint formed between the first and second housing segments 23, 24, an aggressive joining process may be utilized in coupling the housing segments 23, 24 to each other at the corresponding seam therebetwee, such as welding or brazing.

When the muffler housing 22 is assembled to the configuration of FIG. 3, the first housing segment 23 includes a first end 31 of the muffler housing 22 in the axial direction corresponding to an inlet end of the muffler housing 22 with respect to the flow of the refrigerant therethrough while the second housing segment 24 includes a second end 32 of the muffle housing 22 in the axial direction corresponding to an outlet end of the muffler housing 22 with respect to the flow of the refrigerant therethrough. The first end 31 of the muffler housing 22 is coupled to an inlet fluid line 17 of the corresponding refrigerant circuit 10 for conveying the refrigerant to the refrigerant muffler 20 while the second end 32 of the muffler housing 22 is coupled to an outlet fluid line 18 of the refrigerant circuit 10 for conveying the refrigerant away from the refrigerant muffler 20. Each of the fluid lines 17, 18 may be any form of cylindrical, axially symmetric, or otherwise tubular pipe, hose, conduit, or the like suitable for conveying the gaseous refrigerant to and from the muffler housing 22. The first end 31 of the muffler housing 22 may be received within and/or otherwise securely affixed to an end of the inlet fluid line 17 in a fluid tight manner via an appropriate joining process (such as welding or brazing) or via connection to a suitable adapter or connector (not shown), as desired. The second end 32 of the muffler housing 22 may similarly be received within and/or otherwise securely affixed to an end of the outlet fluid line 18 in a fluid tight manner via an appropriate joining process or via connection to a suitable adapter or connector (not shown). The inlet fluid line 17, the assembled muffler housing 22, and the outlet fluid line 18 may all be arranged coaxially along the central axis of the refrigerant muffler housing 20.

The assembled muffler housing 22 (comprising the first and second housing segments 23, 24) generally includes a circumferential wall 33 extending from the first end 31 to the opposing second end 32 of the muffler housing 22 with an inner circumferential surface 34 of the circumferential wall 33 defining a flow opening through the muffler housing 22 from the first end 31 thereof connected to the inlet fluid line 17 to the second end 32 thereof connected to the outlet fluid line 18. The flow opening through the muffler housing 22 is divisible into an inlet chamber 35 formed at the upstream-arranged first end 31 of the muffler housing 22, an expansion chamber 36 disposed adjacent and downstream of the inlet chamber 35, and an outlet chamber 37 formed at the downstream-arranged second end 32 of the muffler housing 22 adjacent the expansion chamber 36.

The inlet chamber 35 is substantially cylindrical in configuration and includes the inner circumferential surface 34 of the muffler housing 22 having a radially inward tapering in the downstream direction of flow of the refrigerant therethrough to form what may be referred to as a Venturi passageway through the inlet chamber 35. As used herein, a Venturi passageway refers to a passageway having a localized contraction of the flow cross-section through the muffler housing 22 to a localized minimum inner diameter (flow area).

In the illustrated embodiment, the Venturi passageway formed by the inlet chamber 35 has a variable taper wherein the inner circumferential surface 34 is initially concave in shape with a progressively increasing slope relative to the central axis of the refrigerant muffler 20 in the downstream direction before the inner circumferential surface 34 transitions to be convex in shape with a progressively decreasing slope relative to the central axis of the refrigerant muffler 20. The inner diameter of the inlet chamber 35 continues to decrease in the downstream direction as a result of the tapering thereof until reaching the minimum localized inner diameter prior to the flow opening transitioning to the expansion chamber 36. The inlet chamber 35 accordingly includes a localized maximum inner diameter at the upstream-arranged first end 31 of the muffler housing 22 and a localized minimum inner diameter at a boundary between the inlet chamber 35 and the expansion chamber 36 where the inner circumferential 34 begins to expand radially outwardly from the localized minimum inner diameter present at the downstream end of the inlet chamber 35. The boundary between the inlet chamber 35 and the expansion chamber 36 may be referred to hereinafter as the inlet 38 into the expansion chamber 36.

The outlet chamber 37 is also substantially cylindrical in configuration and includes the inner circumferential surface 34 of the muffler housing 22 having a radially inward tapering in the downstream direction to form another Venturi passageway having a similar configuration to that of the inlet chamber 35 at a position downstream of the expansion chamber 36, but with the configuration of the outlet chamber 37 arranged symmetrically (mirrored) relative to the inlet chamber 35 with respect to a plane extending perpendicular to the central axis of the muffler housing 22, such as a plane defined by the seam between the first and second housing segments 23, 24. Specifically, the outlet chamber 37 progresses in the downstream direction from a localized minimum inner diameter (flow area) to first include a convex shape with a progressively increasing slope relative to the central axis of the refrigerant muffler 20 before transitioning to a concave shape with a progressively decreasing slope relative to the central axis. An outlet 39 from the expansion chamber 36 is formed by a boundary between the expansion chamber 36 and the outlet chamber 37 where the inner circumferential surface 34 of the muffler housing 22 along the expansion chamber 36 first reaches the localized minimum inner diameter when progressing in the downstream direction.

The Venturi passageways formed in the inlet chamber 35 and the outlet chamber 37 may include a contrary configuration that disclosed in FIG. 3 for forming the localized reduction in flow area at the inlet 38 into the expansion chamber 36 and the outlet 39 therefrom. For example, instead of each of the Venturi passageways having the variable slope having convex and concave segments as disclosed in FIG. 3, the taper of each of the Venturi passageways may be substantially constant in slope to result in each of the Venturi passageways having a substantially frustoconical shape with a decreasing inner diameter in a direction towards the centrally located expansion chamber 36.

The inlet chamber 35 and the outlet chamber 37 may be provided with the tapered configurations thereof for forming the described Venturi passageways in order to improve the acoustic wave attenuating capabilities of the muffler housing 22 in destructively cancelling out acoustic waves of a specified frequency or range of frequencies. That is, it has been discovered that the presence of the localized reduction in flow area at the inlet 38 into and at the outlet 39 from the expansion chamber 36 improves the ability of the muffler housing 22 to attenuate acoustic waves in accordance with the primary objective of the refrigerant muffler 20, hence such a feature may be beneficially incorporated directly into the structure of the muffler housing 22 for providing such an improvement. The muffler housing 22 having the Venturi passageways formed therein may achieve this improvement in acoustic attenuation by a combination of creating pressure variations in the refrigerant flow, facilitating acoustic reflection and interference via an increased surface area of the axial end surfaces of the expansion chamber 36, and inducing turbulence in the refrigerant flow via the acceleration thereof, all of which may contribute to reducing the intensity of the acoustic waves and creating a quieter environment.

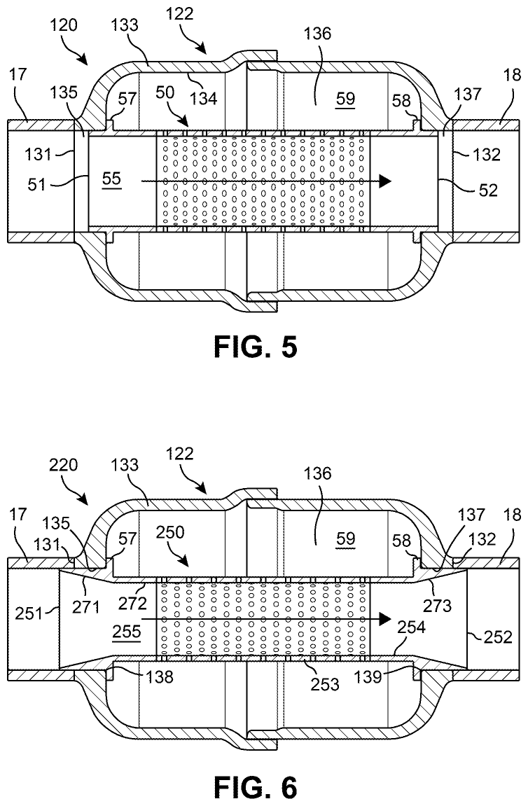

However, as explained hereinafter with reference to the embodiments disclosed in FIGS. 5 and 6, the muffler housing 22 may be provided in the absence of such Venturi passageways while remaining within the scope of the present invention, so long as the corresponding muffler housing 22 is provided with a configuration for accomplishing the desired attenuation of acoustic waves in accordance with the present disclosure.

The inner circumferential surface 34 of the muffler housing 22 along the expansion chamber 36, when progressing in the downstream direction of flow of the refrigerant, generally includes a first axial end surface where the inner circumferential surface 34 expands radially outwardly from the localized minimum inner diameter at the inlet 38 into the expansion chamber 36, an axially extending surface where the expansion chamber 36 has a substantially constant inner diameter (when excluding the outward flaring at the seam present between the housing segments 23, 24) corresponding to a nominal inner diameter of the expansion chamber 36, and a second axial end surface where the inner circumferential surface 34 reduces radially inwardly from the nominal inner diameter to the localized minimum inner diameter at the outlet 39 from the expansion chamber 36. In the present embodiment, the inner circumferential surface 34 is substantially frustoconical along each of the axial end surfaces and cylindrical along the axially extending surface, and includes a convex surface where each of the axial end surfaces transitions from or to the corresponding inlet 38 or outlet 39 and a concave surface where each of the axial end surfaces transitions to or from the axially extending surface. However, it should be readily apparent to one skilled in the art that the muffler housing 22 may include a contrary configuration of the described surfaces for prescribing a desired interaction between the inner circumferential surface 34 and the acoustic waves passing through the muffler housing 22 while remaining within the scope of the present invention, so long as the transition from the inlet chamber 35 to the expansion chamber 36 and then from the expansion chamber 36 to the outlet chamber 37 results in the desired attenuation of acoustic waves according to the objective of the present invention.

In all circumstances, the localized minimum inner diameter (flow area) present at the inlet 38 and the localized minimum inner diameter (flow area) present at the outlet 39 are always selected to be smaller than the nominal inner diameter (flow area) present along the axially extending surface of the expansion chamber 36 to result in the expansion and contraction of the flow opening formed through the muffler housing 22 when progressing in the downstream direction of flow. As shown in FIG. 3, the inlet 38 and the outlet 39 may include the same inner diameter, the ends 31, 32 of the muffler housing 22 may each include the same inner diameter (flow area) which is greater than that of the inlet 38 or outlet 39, and the inlet fluid line 17 and the outlet fluid line 18 may also include the same inner diameter (flow area) as each of the ends 31, 32 received therein. However, the refrigerant muffler 20 is not necessarily limited to the symmetric arrangement of the inlet and outlet ends thereof, as alternative forms of expansion and contraction of the flow opening through the muffler housing 22 may be utilized while remaining within the scope of the present invention.

The flow control insert 50 extends axially from a first end 51 to an oppositely arranged second end 52 thereof, wherein the first end 51 is disposed towards the inlet chamber 35 and the first end 31 of the muffler housing 22 while the second end 52 is disposed towards the outlet chamber 37 and the second end 32 of the muffler housing 22. The flow control insert 50 is substantially tubular in configuration and includes a cylindrically shaped circumferential wall 53 with an inner circumferential surface 54 thereof defining an axially extending flow pathway 55 through the flow control insert 50 from the first end 51 to the second end 52 thereof. The flow pathway 55 is positioned to extend across at least a portion, if not an entirety of, the expansion chamber 36 with respect to the axial direction thereof to cause the flow pathway 55 to provide fluid communication between the inlet chamber 35 and the outlet chamber 37 for the flow of the refrigerant through the refrigerant muffler 20. More specifically, the embodiment illustrated in FIG. 3 includes the first end 51 of the flow control insert 50 disposed beyond the inlet 38 and within the inlet chamber 35 and the second end 52 of the flow control insert 50 disposed beyond the outlet 39 and within the outlet chamber 37 to cause the flow pathway 55 to extend across an entirety of the axial length of the expansion chamber 36, thereby allowing the flow pathway to provide direct fluid communication between the inlet chamber 35 and the outlet chamber 37 when flowing through the refrigerant muffler 20. An outer circumferential surface 56 of the circumferential wall 53 may accordingly include an outer diameter that is substantially equal to or slightly smaller than the localized minimum inner diameter of the inner circumferential surface 34 of the muffler housing 22 at each of the inlet 38 and the outlet 39 of the expansion chamber 36 to allow for the axial insertion of each of the ends 51, 52 of the flow control insert 50 within each of the respective inlet and outlet chambers 35, 37.

A first retaining projection 57 projects radially outwardly from the outer circumferential surface 56 of the circumferential wall 53 adjacent the first end 51 of the flow control insert 50 and a second retaining projection 58 projects radially outwardly from the outer circumferential surface 56 of the circumferential wall 53 adjacent the second end 52 of the flow control insert 50. Each of the retaining projections 57, 58 may include a substantially cylindrical or annular shape configured to cooperate with a corresponding feature of the inner circumferential surface 34 of the muffler housing 22 for establishing a desired position and/or orientation of the flow control insert 50 within the muffler housing 22. In the embodiment illustrated in FIG. 3, the first retaining projection 57 is configured to axially engage the inner circumferential surface 34 along the first axial end surface of the expansion chamber 36 to delimit continued axial insertion of the first end 51 of the flow control insert 50 into the inlet chamber 35 and the second retaining projection 58 is configured to axially engage the inner circumferential surface 34 along the second axial end surface of the expansion chamber 36 to delimit continued axial insertion of the second end 52 of the flow control insert 50 into the outlet chamber 37. The flow control insert 50 is accordingly retained between the first and second housing segments 23, 24 in the configuration shown in FIG. 3 when the first and second housing segments 23, 24 are axially assembled to each other with the ends 51, 52 of the flow control insert 50 received into the corresponding inlet/outlet chambers 35, 37 of the respective housing segments 23, 24.

The flow control insert 50 is characterized in that at least a portion, if not an entirety, of an axially extending length of the circumferential wall 53 disposed along the expansion chamber 36 is porous and/or perforated in a manner wherein the presence of the flow control insert 50 within the muffler housing 22 has a negligible effect on the acoustic wave attenuating capabilities of the muffler housing 22. That is, it has surprisingly been discovered that the flow control insert 50 can be provided to include a configuration, via a preselected degree of porosity of the circumferential wall 53 along the specified segment(s) thereof, that when installed into the muffler housing 22 can direct a flow of the refrigerant through the expansion chamber 36 (via passage through the flow pathway 55 of the flow control insert 50) without having an appreciable effect on the performance of the muffler housing 22 in attenuating the desired frequency or range of frequencies of acoustic waves experienced within the refrigerant muffler 20. In other words, testing of the illustrated muffler housing 22 in isolation as well as testing of the refrigerant muffler 20 having an assembly of the muffler housing 22 and the flow control insert 50 results in the same performance of each respective muffler housing 22 in attenuating the desired acoustic waves such that the results of the differing tests are indistinguishable from one another. It has accordingly been discovered that the flow control insert 50 may be preselected to be, in essence, non-interactive with the process of attenuating the acoustic waves within the expansion chamber 36 via destructive interference therebetween despite the presence of the flow control insert 50 within the expansion chamber 36.

However, despite the flow control insert 50 having no appreciable effect on the acoustic wave attenuating capabilities of the refrigerant muffler 20, it has also been surprisingly discovered that the flow control provided by the shape and configuration of the centrally located flow pathway 55, which includes a smaller inner diameter than does the surrounding inner circumferential surface 34 along the expansion chamber 36, results in a significantly reduced pressure drop of the refrigerant when passing through the assembly of the flow control insert 50 and the muffler housing 22 of the illustrated refrigerant muffler 20 in comparison to passage through the muffler housing 22 in the absence of the presence of the flow control insert 50. This effect is caused by the minimization or elimination of the radial outward expansion of the flow of the refrigerant when otherwise encountering the outward expansion of the inner circumferential surface 34 at the inlet 38 to the expansion chamber 36. This occurs due to the inner circumferential surface 54 of the flow control element 50 defining a direct flow path for the refrigerant between the inlet 38 and the outlet 39 of the expansion chamber 36. More specifically, the inward facing surfaces of the inner circumferential surface 54 act to delimit radial outward expansion of the flow of the refrigerant through the flow pathway 55. Any potential pressure loss caused by the porosity or perforated structure of the circumferential wall 53 along the corresponding length of the inner circumferential surface 54 thereof is overcome by the prevention of the pressure loss typically caused by the expansion and subsequent contraction of the refrigerant flow when otherwise passing through such an expansion chamber absent the presence of the flow control insert 50 according to the present invention.

Additionally, although the porosity and/or perforated configuration of the circumferential wall 53 allows for the refrigerant to potentially be fluidly communicated to an annular or cylindrical space 59 formed between the outer circumferential surface 56 of the flow control insert 50 and the inner circumferential surface 34 of the muffler housing 22, the flow of the refrigerant primarily flows axially within the fluid pathway 55 and with a minimized incidence of radial outward flow through the pores or perforations formed through the circumferential wall 53. The porosity of the circumferential wall 53 is accordingly selected to prevent excessive flow between the flow pathway 55 and the annular space 59 while still maintaining acoustic communication between any acoustic waves passing through the flow pathway 55 and the inner circumferential surface 34 along the expansion chamber 36, by way of the annular space 59, when the acoustic waves expand outwardly when encountering the pores or perforations formed through the circumferential wall 53 of the flow control insert 50. This redirecting of the flow of the refrigerant through the flow pathway 55 also effectively aids in the elimination of the formation of recirculation zones of the refrigerant within the expansion chamber 36.

FIG. 12 is a chart showing a tested difference in pressure drop of a refrigerant experienced within two different refrigerant muffler configurations relative to the pressure drop of the refrigerant when passing through a straight cylindrical pipe of the same length, with respect to a variable flow rate of the refrigerant through each structure. Line A corresponds to the tested pressure drop experienced within a refrigerant muffler configuration having only a muffler housing in the absence of a flow control insert (the muffler housing 22 in isolation) while Line B corresponds to the tested pressure drop experienced within a refrigerant muffler 20 according to the embodiment of FIG. 3 having the flow control insert 50 disposed within the assembled muffler housing 22. As can be seen by review of FIG. 12, the additional pressure drop beyond that of a straight pipe as experienced by the refrigerant within the isolated muffler housing is around twice that experienced by the refrigerant within the refrigerant muffler 20 of the present invention across all tested flow rates. The incorporation of the flow control insert 50 into the muffler housing 22 accordingly has a significant impact on the pressure loss experienced by the refrigerant when passing through the refrigerant muffler 20, hence the efficiency and performance of the corresponding refrigerant circuit 10 can be substantially improved via the addition of the flow control insert 50 to the muffler housing 22 without any appreciable downside regarding the attenuating of acoustic waves within the refrigerant muffler 20 according to the configuration of the muffler housing 22.

FIG. 3 illustrates one of multiple different embodiments of the flow control insert 50 that may be incorporated into a corresponding muffler housing while remaining within the scope of the present invention. The circumferential wall 53 of the flow control insert 50 is divided into a first frame section 61 including the first end 51, a porous section 62 adjacent the first frame section 61 in the downstream direction of flow, and a second frame section 63 including the second end 52 disposed adjacent the porous section 62 in the downstream direction of flow. The first frame section 61 and the second frame section 63 may be provided in the absence of pores and/or perforations for maintaining a desired structural robustness of the flow control insert 50 at each of the ends 51, 52 thereof in engagement with the inner circumferential surface 34 of the muffler housing 22 when the first and second housing segments 23, 24 are axially assembled. However, in some embodiments, the first and second frame sections 61, 63 may include some degree of porosity or may include perforations formed therethrough. The porous section 62 of the circumferential wall 53 forms a length thereof having the pores/perforations for providing acoustic communication between the flow pathway 55 and the annular space 59 surrounding the flow control insert 50 for maintaining the capabilities of the muffler housing 22 in attenuating desired acoustic waves.

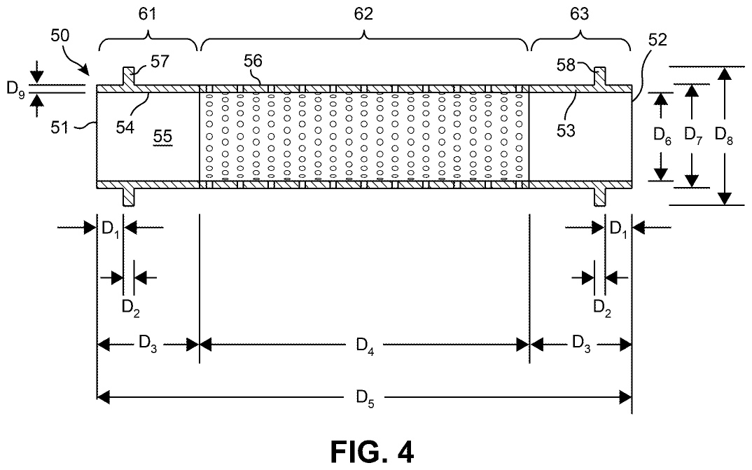

FIG. 4 illustrates various different dimensions of the flow control insert 50 that may be varied for producing the desired robustness of the flow control insert 50 while maintaining the described advantages of the flow control insert 50 in directing refrigerant flow and communicating acoustic waves. The dimensions include a dimension D₁ corresponding to an axial distance present between the first end 51 of the circumferential wall 53 and the facing surface of the first retaining projection 57 (also corresponding to the distance present between the second end 52 and the facing surface of the second retaining projection 58), a dimension D₂ corresponding to an axial thickness of the first retaining projection 57 between opposing faces thereof (also corresponding to an axial thickness of the second retaining projection 58), a dimension D₃ corresponding to an axial length of the first frame section 61 (also corresponding to an axial length of the second frame section 63), a dimension D₄ corresponding to an axial length of the porous section 62, a dimension D₅ corresponding to total length of the flow control insert 50/circumferential wall 53 between the opposing ends 51, 52 thereof, a dimension Do corresponding to an inner diameter of the inner circumferential surface 54 of the circumferential wall 53 defining the flow pathway 55, a dimensions D₇ corresponding to an outer diameter of the outer circumferential surface 56 of the circumferential wall 53, a dimension D₈ corresponding to an outer diameter of each of the retaining projections 57, 58, and a dimension Do corresponding to a radially extending thickness of the circumferential wall 53, or of at least the frame sections 61, 63 of the circumferential wall 53.

The first and second frame sections 61, 63 may each include the dimension D₃ being equal to or less than 20% of the value D₅, thereby resulting in a maximum combined axial extension of the frame sections 61, 63 being 40% of the total length D₅ of the flow control insert 50. The values of D₁, D₇, and D₈ may be selected to accommodate alternative configurations and/or dimensions of the muffler housing into which the flow control insert 50 is inserted while maintaining a desired position and orientation of the flow control insert 50 therein. The values of D₂, D₃, and Do may be selected to provide desired robustness to the flow control insert 50 when installed or when encountering operating conditions. The value of D₆ may be selected to be in the range of 90-125% of the localized minimum inner diameter of the inlet chamber 35 at the inlet 38 into the expansion chamber 36, thereby preventing excessive expansion of the refrigerant when flowing through the flow pathway 55. The radial thickness of the circumferential wall 53 along the porous section 62 may also be equal to that along the frame sections 61, 63, or may differ therefrom due to the inclusion or formation of the pores or perforations therein. For example, the porous section 62 may be provided to include a reduced thickness relative to the frame sections 61, 63 for minimizing the thickness of the circumferential wall 53 through which the pores or perforations must penetrate while still forming a barrier against which the refrigerant cannot freely expand radially outwardly.

The porous section 62 of the circumferential wall 53 is shown in FIGS. 3 and 4 as having an arrangement of the pores or perforations formed therein with the pores or perforations penetrating the thickness of the circumferential wall 53 to cause the pores or perforations to be radially extending through-holes of the circumferential wall 53. The pores or perforations may have any suitable perimeter shape, including circular, elliptical, rectangular, slotted, irregular, multi-sided polygonal, etc., and may be disposed in any ordered or non-ordered/irregular arrangement, so long as the circumferential wall 53 is provided with the necessary degree of porosity for establishing the beneficial properties of the flow control insert 50 described herein.

Specifically, it has been discovered that with respect to a circumferential wall 53 that is relatively thin in thickness along the porous section 62 thereof, such as having a thickness of 1 mm or less, that a porosity of the circumferential wall 53 along the porous section 62 in the range of about 10-25% results in the flow control insert 50 being able to direct the flow of the refrigerant axially through the flow pathway 55 without experiencing a significant pressure drop while also maintaining the acoustic communication through the circumferential wall 53 that is necessary for maintaining the acoustic wave attenuating capabilities of the muffler housing 22. As utilized herein, the porosity of the circumferential wall 53 when expressed as a percentage refers to a ratio of the surface area of the open spaces provided along a given region of the inner circumferential surface 54 of the circumferential wall 53 as formed by the corresponding pores/perforations thereof to the total surface area of the given region of the inner circumferential surface 54. The porosity of the circumferential wall 53 is accordingly based on a combination of pore/perforation size and the spacing between adjacent pores/perforations. The porosity of the circumferential wall 53 may be described with reference to the described percentage value only when the radial thickness of the circumferential wall 53 is small enough to establish the pores or perforations as the described through-holes penetrating the thickness of the circumferential wall 53 from the inner circumferential surface 54 to the outer circumferential surface 56 thereof, thereby providing acoustic communication between the inner and outer circumferential surfaces 54, 56 via the pores or perforations.

It has also been discovered that a circumferential wall 53 having a porosity of less than 10% along the porous section 62 thereof may not result in the flow control insert 50 having the beneficial properties and capabilities described herein. More specifically, it has been discovered that a porosity of less than 10% results in the pores/perforations of the flow control insert 50 having a Helmholtz resonator tuning effect, which in turn causes the flow control insert 50 to have a significant effect on the acoustic attenuating capabilities of the resulting refrigerant muffler in a manner not consistent with the objectives of the present invention. The presence of the flow control insert 50 within the muffler housing 22, and more specifically, the porous section 62 of the circumferential wall 53 as described herein, may accordingly be said to not result in the presence of a Helmholtz resonator within the muffler housing 22. The flow control insert 50 of the present invention is accordingly distinguished from porous or perforated structures disposed within a muffler housing and configured to act as such a Helmholtz resonator, or to specifically have such a Helmholtz tuning effect, as such structures operate according to contrary principles that do not apply to the inventive solution provided by the present disclosure.

In some embodiments, the flow control insert 50 may be formed from one or more polymeric materials, such as one or more suitable plastics. More specifically, the frame sections 61, 63 and the porous section 62 of the circumferential wall 53 may both be formed from polymeric materials, including all of the sections 61, 62, 63 being formed from a common polymeric material, or the porous section 62 being formed from a different polymeric material than the frame sections 61, 63. In other embodiments, the flow control insert 50 may be formed from one or more metallic materials. Again, the frame sections 61, 63 may be formed from a different metallic material than the porous section 62, or all of the sections 61, 62, 63 may be formed from a common metallic material. According to other embodiments, the frame sections 61, 63 may be formed from a metallic material while the porous section 62 may be formed from a polymeric material, or the frame sections 61, 63 may be formed from a polymeric material while the porous section 62 is formed from a metallic material.

The flow control insert 50 may be manufactured in an injection molding process where one or all of the sections 61, 62, 63 described herein are formed by the injection molding process. As one example, the embodiment disclosed in FIGS. 3 and 4 may be formed in a multi-step polymer injection molding process wherein the frame sections 61, 63 are formed as a carrier in a first injection molding process and the porous section 62 is then over-molded onto the frame sections 61, 63 as a non-woven polymer screen extending therebetween. The non-woven polymer screen may be molded to include any desired pore/perforation configuration for providing the porous section 62 at the described 10-25% porosity with respect to a relatively thin-walled flow control insert 50 (such as 1 mm or less). As mentioned previously, the polymer screen forming the porous section 62 may be provided to include the same or a different thickness than the remainder of the circumferential wall 53, such as having a reduced thickness from the adjoining frame sections 61, 63 as a result of the over-molding process utilized in forming the porous section 62 as the non-woven polymer screen.

The pores/perforations are not limited to being formed in the porous section 62 via the described injection molding process. The porous section 62 may be formed by any process, including precision cutting the pores/perforations from the circumferential wall 53, such as laser-cutting perforations into a metallic tube forming the flow control insert 50. The porous section 62 may be provided as an independently manufactured screen that is then coupled to the opposing frame sections 61, 63, as desired.

The porous section 62 has thus far been described with reference to a plurality of the pores/perforations being provided as through-holes of the circumferential wall 53, thereby allowing for the measure of porosity to be expressed as the percentage of open surface area of a given region of the circumferential wall 53. However, in some circumstances, the porous section 62 may instead be provided as a porous material having pores that do not extend across the thickness of the circumferential wall 53 for forming such through-holes. Any acoustic communication occurring through the pores of the circumferential wall 53 may thus occur via a tortuous path comprising multiple pores in communication with each other. Such a circumstance may occur when the thickness of the circumferential wall 53 is selected to be relatively large to preclude the penetration of the pores therethrough, such as being greater than 1 mm in thickness. Such a porous material may be a sintered metallic material or a sintered polymer material, as non-limiting examples of porous materials suitable for use in the flow control insert 50. The sintered porous material may comprise only the porous section 62, or may be utilized in forming the entirety of the circumferential wall 53, as desired.

When such pores do not extend across the thickness of the circumferential wall 53, it has been discovered that an alternative measure of the porous nature of the material forming the porous section 62 alternative to the previously described percentage value of open space must be utilized in determining whether the porous section 62 has the desirable properties described herein. Specifically, it has been discovered that such a porous material has the requisite characteristics when the pore size of the porous material is greater than 900 μm. As one example, the porous material may have an average pore size of 1200 μm with the pores forming the porous material falling within a range of 900-1500 μm.

Referring now to FIG. 5, a refrigerant muffler 120 having a modified muffler housing 122 is disclosed. The muffler housing 122 of FIG. 5 differs from the muffler housing 22 of FIG. 3 in that the muffler housing 122 does not include the formation of what has been referred to as a Venturi passageway within either of an inlet chamber 135 or an outlet chamber 137 thereof. Instead, an inner circumferential surface 134 of the circumferential wall 133 of the muffler housing 122 includes a constant inner diameter (flow area) along each of the inlet chamber 135 and the outlet chamber 137, thereby resulting in each of the chambers 135, 137 being defined by an axially extending cylindrical segment of the inner circumferential surface 134. The inner circumferential surface 134 may include an inner diameter along each of the chambers 135, 137 that corresponds to the inner diameter of each of the fluid lines 17, 18, and the opposing ends 131, 132 of the muffler housing 122 may form a butt joint with respect to a facing end of each of the respective fluid lines 17, 18.

The refrigerant muffler 120 of FIG. 5 includes a flow control insert 50 having the same configuration as that disclosed in FIG. 3, but with modifications to various dimensions identified in FIG. 4 for accommodating the different configuration of the inner circumferential surface 134 resulting from the omission of the formation of a Venturi passageway within each of the opposing inlet and outlet chambers 135, 137. The flow control insert 50 still provides fluid communication between the inlet chamber 135 and the outlet chamber 137 while traversing the expansion chamber 136 via passage of the refrigerant through the corresponding flow pathway 55. The first end 51 of the flow control insert 50 may be received within the inlet chamber 135 while the second end 52 of the flow control insert may be received within the outlet chamber 137 to provide direct fluid communication therebetween via the flow pathway 55. Each of the retaining projections 57, 58 projecting radially outwardly from the circumferential wall 53 may also include any corresponding shape and configuration for locating and/or retaining a position and orientation of the flow control insert 50 relative to the muffler housing 122.

As mentioned previously, the removal of the Venturi passageway from each of the inlet chamber 135 and the outlet chamber 137 may result in a reduction of the ability of the muffler housing 122 to attenuate certain acoustic waves in comparison to the configuration of the muffler housing 22. However, the muffler housing 122 otherwise operates in substantially the same manner as the muffler housing 22, and the flow control insert 50 similarly provides the same functionality when installed in the contrary configuration of the muffler housing 122. That is, the flow control insert 50 maintains the capability to reduce the pressure drop experienced by the refrigerant passing through the refrigerant muffler 120 in comparison to the use of the muffler housing 122 in isolation, and also does not have an appreciable effect on the ability of the muffler housing 122 to attenuate the desired acoustic waves due to the porous and/or perforated configuration thereof. The flow control insert 50 also does not correspond to the formation of a Helmholtz resonator therein as the result of the porosity and/or perforated configuration thereof.

FIG. 6 illustrates a refrigerant muffler 220 having a modified flow control insert 250 according to another embodiment of the invention that is also suitable for incorporation into a muffler housing 122 having the configuration disclosed with reference to FIG. 5 wherein the inlet and outlet chambers 135, 137 are devoid of the formation of one of the Venturi passageways therein. The flow control insert 250 includes a circumferential wall 253 having an inner circumferential surface 254 defining the flow pathway 255 therethrough between the opposing first and second ends 251, 252 of the flow control insert 250. The flow pathway 255 differs from the flow pathway 55 of FIG. 3 in that the flow pathway 255 includes the inner circumferential surface 254 defining an inlet tapered segment 271 at or adjacent the first end 251 of the flow control insert 250, an axially extending segment 272 adjacent the inlet tapered segment 271 in the downstream direction of flow, and an outlet tapered segment 273 at or adjacent the second end 251 of the flow control insert 250 and adjacent the axially extending segment 272 in the downstream direction of flow. The inlet tapered segment 271 includes an inner diameter of the inner circumferential surface 254 decreasing progressively in the downstream direction of flow while the outlet tapered segment 273 includes an inner diameter of the inner circumferential surface 254 increasing progressively in the downstream direction of flow. Each of the tapered segments 271, 273 is shown as having a constant taper to result in a frustoconical shape, but alternative tapers may be utilized while remaining within the scope of the present invention, including a taper corresponding to Venturi passageways illustrated in FIG. 3.

The inlet tapered segment 271 forms a Venturi passageway at or adjacent an inlet 138 into the expansion chamber 136 of the muffler housing 122 while the outlet tapered segment 273 forms a Venturi passageway at or adjacent the outlet 139 from the expansion chamber 136. The incorporation of the modified flow control insert 250 into the muffler housing 122 accordingly allows for the recreation of the beneficial conditions provided by the refrigerant muffler 20 having the muffler housing 22 with Venturi passageways incorporated into the inlet and outlet chambers 35, 37 thereof, as the refrigerant still encounters a corresponding Venturi passageway when entering and exiting the expansion chamber 136 via the flow pathway 255 despite the simplified configuration of the muffler housing 122.

The flow control insert 250 otherwise includes the same structural features as described with reference to the flow control insert 50 for controlling the flow of the refrigerant through the refrigerant muffler 220 while simultaneously having a negligible effect on the acoustic wave attenuating capabilities of the refrigerant muffler 220 as a result of the porous and/or perforated configuration of the circumferential wall 253 of the flow control insert 250 within the expansion chamber 136 of the muffler housing 122. For example, the flow control insert 250 may be formed from any of the materials described as suitable for use in the flow control insert 50 and may include the same configuration of any pores or perforations formed within the circumferential wall 253 for prescribing the desired characteristics of the flow control insert 250 in accordance with the present disclosure. As can be seen in FIG. 6, the structure of the flow control insert 250 may be modified at each of the ends 251, 252 thereof to accommodate the contrary configuration of the muffler housing 122 as well as the inward tapering of the flow pathway 255 towards the axially extending segment 272 thereof when attempting to maintain the same thickness of the circumferential wall 253 along the axially extending segment 272.

The refrigerant muffler 220 operates in the same manner as the refrigerant muffler 20 while appreciating the same benefits of the formation of the flow pathway 255 through the expansion chamber 136 for reducing the pressure drop experienced by the refrigerant when passing through the refrigerant muffler 220. Specifically, the flow control insert 250 does not have an appreciable effect on the capability of the refrigerant muffler 220 to attenuate acoustic waves via the destructive interference of the acoustic waves within the expansion chamber 136, with the exception of the described benefits of the inclusion of one of the Venturi passageways at each of the ends of the flow pathway 255. Specifically, the inclusion of the Venturi passageways within the flow control insert 250 does not alter the manner in which the porosity and/or perforated configuration of the circumferential wall 253 along the expansion chamber 136 has been discovered to otherwise have no appreciable effect on the capabilities of the refrigerant muffler 220 to attenuate acoustic waves via the acoustic, and the flow control insert 250 does not correspond to the formation of a Helmholtz resonator or the like within the refrigerant muffler 220.

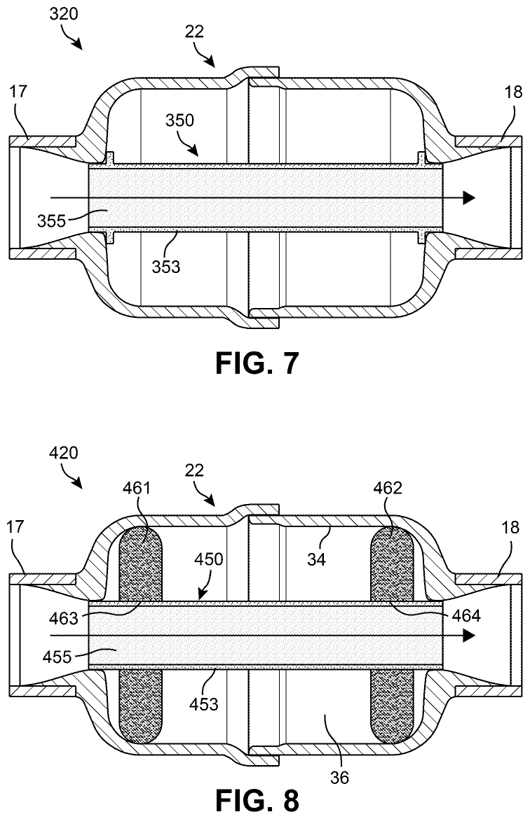

Referring now to FIG. 7, a flow control insert 350 of a refrigerant muffler 320 according to another embodiment of the present invention is disclosed. The flow control insert 350 includes substantially identical structure as the flow control insert 50 and thus may be configured for installation into the muffler housing 22, but does not include the division of the circumferential wall 353 thereof into distinct frame sections and a porous section. Instead, an entirety of the flow control insert 350 is provided as a porous material having the necessary porosity or pore size specified herein in the absence of dedicated frame sections, with the porous material extending across an entirety of the flow pathway 355 defined by the circumferential wall 353. The flow control insert 350 may be formed from a sintered polymer or a sintered metal, as non-limiting examples of porous materials. It should be readily apparent that the flow control insert 350 formed of the porous material may also be modified for installation into the muffler housing 122 devoid of the Venturi passageways while remaining within the scope of the present invention.

FIG. 8 illustrates a flow control insert 450 of a refrigerant muffler 420 according to yet another embodiment of the present invention. The flow control insert 450 includes a tubular and cylindrical circumferential wall 453 in substantially similar fashion to the flow control insert 50, wherein the circumferential wall 453 defines the flow pathway 455 of the flow control insert 450. However, the flow control insert 450 differs from the flow control insert 50 in that flow control insert 450 includes a first centering disc 461 disposed around the circumferential wall 453 via a central opening 463 thereof towards a first end 451 of the flow control insert 450 as well as a second centering disc 462 disposed around the circumferential wall 453 via a central opening 464 thereof towards a second end 452 of the flow control insert 450. The circumferential wall 453 may also be formed entirely of the porous material in similar fashion to the circumferential wall 353, as opposed to having the dedicated sections 61, 62, 63 thereof with potentially differing constructions.

The first and second centering discs 461, 462 each include an outer diameter substantially equal to the inner circumferential surface 34 of the muffler housing 22 along the expansion chamber 36 thereof to cause the centering discs 461, 462 to centrally locate the circumferential wall 453 relative to the central axis of the muffler housing 22 when the housing segments 23, 24 are axially assembled around the flow control insert 450. In some embodiments, the centering discs 461, 462 may be formed from a rigid material with the centering discs 461, 462 closely received within the corresponding housing segments 23, 24. In other embodiments, the centering discs 461, 462 may be provided as a flexible material capable of resiliently adjusting a radial misalignment of the central axis of the flow control insert 450 relative to the central axis of the muffler housing 22 when an outer circumferential surface of each of the centering discs 461, 462 is compressed against the inner circumferential surface 34 along the expansion chamber 36. In such a circumstance, the outer diameter of the centering discs 461, 462 may be selected to be slightly greater than the inner circumferential surface 34 of the muffler housing 22 along the expansion chamber 36 to promote a press-fit insertion of the centering discs 461, 462 into the muffler housing 22 during insertion into the corresponding housing segments 23, 24.

A material forming each of the centering discs 461, 462 may also be selected to include a suitable porosity for allowing acoustic communication therethrough in a manner not negatively affecting the acoustic attenuating capabilities of the muffler housing 22, such as having the pore size of greater than 900 μm specified hereinabove with reference to the porous section of the circumferential wall. However, the centering discs 461, 462 may alternatively be provided in the absence of the pores where the centering discs 461, 462 are positioned such that the centering discs 461, 462 do not have a significant interaction with the acoustic waves passing through the annular space 59.

The first and second centering discs 461, 462 may also be positioned axially along the circumferential wall 453 in a manner wherein each of the centering discs 461, 462 encounters a surface of the circumferential surface 34, such as one of the radially extending axial end surfaces or a transition to one of the axial end surfaces, in an axially delimiting manner for establishing a position of each of the ends of the circumferential wall 453 relative to the corresponding features of the muffler housing 22. Each of the centering discs 461, 462 may accordingly be said to alternatively be representative of one of the retaining projections 57, 58 described hereinabove with reference to the flow control insert 50, wherein the centering discs 461, 462 aid in positioning the flow control insert 450 both axially and radially during assembly of the refrigerant muffler 420. Although not pictured in FIG. 8, the circumferential wall 453 may further be provided to include an additional retaining projection similar to one of the retaining projections 57, 58 of the flow control insert 50 adjacent each of the opposing axial ends thereof in order to provide the same functionality as the retaining projections 57, 58 in affixing a position and orientation of the flow control insert 450 adjacent each end thereof, or for adding robustness to the flow control insert 450 adjacent the ends thereof.

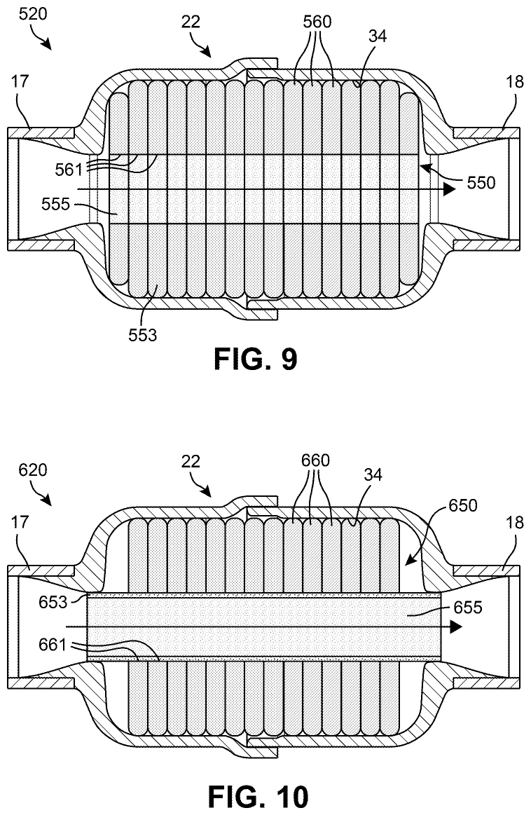

Referring now to FIG. 9, a refrigerant muffler 520 having a contrary construction of a flow control insert 550 disposed within the muffler housing 22 is disclosed according to another embodiment of the present invention. The flow control insert 550 includes a tubular circumferential wall 553 thereof formed by the cooperation of a plurality of axially stacked disc elements 560, each of which includes a centrally disposed flow opening 561 formed therethrough. When the disc elements 560 are stacked axially within the muffler housing 22 into the configuration of FIG. 9, the flow openings 561 are aligned in the axial direction to form the flow pathway 555 of the flow control insert 550 through which the refrigerant flows without undergoing an undesirable radial outward expansion when passing through the expansion chamber 36. Each of the flow openings 561 may accordingly include an inner diameter in the range of 90-125% of the inner diameter at the inlet 38 into the expansion chamber 36, The circumferential wall 553 may include a desired number and/or a desired axial thickness of each of the plurality of the disc elements 560 to result in the circumferential wall 553 extending axially across the expansion chamber 36 for preventing the undesirable radial outwardly expansion of the refrigerant. Each of the disc elements 560 may also be provided to include an outer diameter suitable for centering the flow pathway 555, properly locating the flow control insert 550 within the muffler housing 22, or retaining a position and orientation of the properly located flow control insert 550 within the muffler housing 22. As illustrated embodiment, each of the disc elements 560 includes an outer diameter substantially equal to or slightly less than that of the inner circumferential surface 34 of the muffler housing 22 at the same axial position substantially constrain the stack of the disc elements 560 in the axial and radial directions for ensuring that the flow pathway 555 is maintained therethrough in the illustrated configuration.

Each of the disc elements 560 is formed from a sufficiently porous material capable of communicating the desired acoustic waves therethrough for interaction with the surrounding inner circumferential surface 34. The use of the porous material throughout the thickness of the circumferential wall 553 may result in the elimination of the open annular space 59 within the expansion chamber 36 where the disc elements 560 contact the inner circumferential surface 34 of the muffler housing 22. Each of the disc elements 560 may accordingly be formed from a sintered metal material or a sintered polymer material, as desired, so long as the pores formed therein are formed to be 900 μm or greater in size (diameter) to facilitate the beneficial properties of the present invention as described hereinabove. As one non-limiting example, where the disc elements 560 are provided as a sintered metal, it has been discovered that the disc elements 560 may be formed from sintered nickel.

FIG. 10 illustrates one possible configuration of a refrigerant muffler 620 according to another embodiment of the present invention, wherein a flow control insert 650 of the refrigerant muffler 620 may be provided as a combination of a tubular cylindrical inner circumferential wall 653 having the same configuration as the circumferential wall 453 and a plurality of disc elements 660 similar in configuration to the disc elements 560, except the central openings 661 of the disc elements 660 receive the circumferential wall 653 therein without defining a flow pathway for the refrigerant, which is instead defined by the inwardly disposed circumferential wall 653 as a flow pathway 655. Each of the circumferential wall 653 and the disc elements 660 may be provided to include the described porosity as a percentage or minimum pore size for providing the beneficial properties of the present invention as described hereinabove.

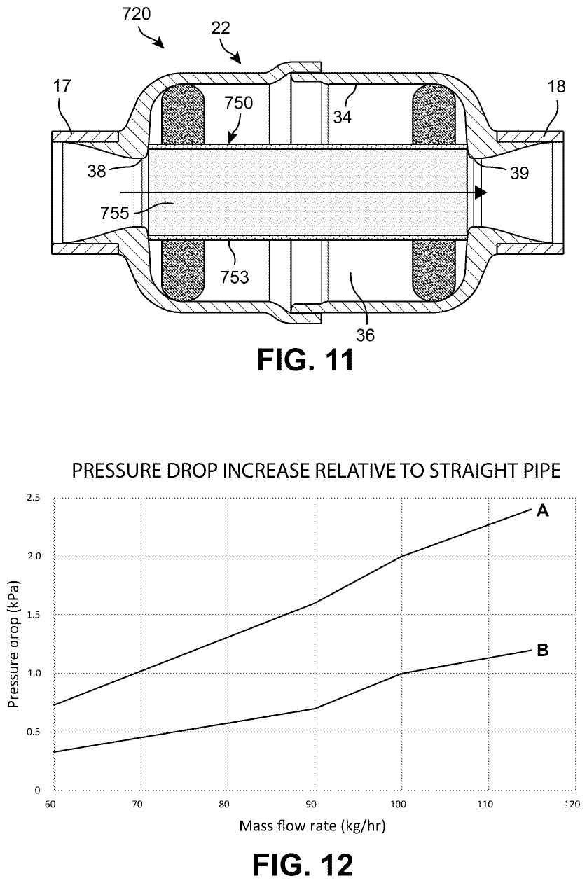

Lastly, FIG. 11 illustrates a refrigerant muffler 720 having a flow control insert 750 according to another embodiment of the present invention, wherein the flow control insert 750 has substantially similar structure as the flow control insert 450, but is modified to include an inner diameter of the flow pathway 755 thereof to be greater than the inner diameter at the inlet 38 into the expansion chamber 36. That is, the flow pathways have been described as having an inner diameter in the range of up to 125% of the inner diameter of the localized minimum inner diameter of the inlet 38 into the expansion chamber 36, and FIG. 11 illustrates one configuration capable of achieving such an enlargement of the flow pathway 755 relative to the inlet 38 via axial abutment of the axial end surfaces of a circumferential wall 753 of the flow control insert 750 with the axial end surfaces of the expansion chamber 36 around the inlet 38 and the outlet 39, respectively. It should be readily apparent that substantially any of the flow control inserts disclosed herein may include the expanded inner diameter of the corresponding flow pathway via a similar adjustment to the structure of the corresponding circumferential wall in accordance with the example of FIG. 11, including the potential modification of any centering features or locating features of the circumferential wall.

It should be apparent that substantially any of the features disclosed with reference to the different embodiments of the flow control insert 50, 250, 350, 450, 550, 650, 750 may be utilized in any of the other disclosed embodiments thereof, whether as replacements or in addition to certain features, so long as the resulting flow control insert includes the same beneficial properties as disclosed herein. For example, the different materials described as forming the flow control inserts, the different types of pores formed within the flow control inserts, and the different retaining/locating/centering features disclosed with regards to the different flow control inserts may be interchanged with one another or utilized in combination so long as the pressure drop experienced through the corresponding flow pathway is reduced without negatively affecting the capability of the corresponding muffler housing in attenuating acoustic waves in a desired manner. It should also be readily apparent that each of the different flow control inserts shown relative to the muffler housing 22 having the Venturi passageways formed therein may be easily adapted for installation into the muffler housing 122 devoid of such a feature, therefore any combination of any of the disclosed flow control inserts with the muffler housing 122 may be considered to be within the scope of the present invention.

The various different refrigerant housings and flow control inserts disclosed herein are also shown and described as having substantially axially symmetric configurations, such as being generally cylindrical, frustononical, or the like, with a corresponding circular cross-sectional shape that varies along a length of each of the respective refrigerant housings and/or flow control inserts. However, it should be apparent that the present invention may be modified for application to substantially any tubular flow configuration, and is not limited to axially symmetric configurations. As utilized herein, the term “tubular” may refer to any structure having a circumferential wall defining an elongate and hollow opening therethrough of any cross-sectional shape, and hence the term tubular is not limited to describing circular cross-sectional shapes. Such tubular configurations may include an opening having a cross-sectional shape of a rectangle, a rounded rectangle, an ellipse, an elongated diamond, or any other multi-sided polygon, as non-limiting exemplary cross-sectional shapes.

Such an alternative tubular configuration may be present in the muffler housing and/or the flow control insert. That is, each of the muffler housing and the corresponding flow control insert may include a similar tubular configuration where a cross-sectional shape of each feature is similar, but with the muffler housing including an inner dimension along at least one axis arranged perpendicular to the axial direction of the muffle housing that is greater than that of the corresponding flow control insert at the same axial position to result in the expansion of the muffler housing along the expansion chamber thereof in comparison to the flow area through the corresponding flow control insert. Alternatively, each of the muffler housing and the corresponding flow control insert may include alternative tubular configurations corresponding to different cross-sectional shapes, so long as the muffler housing includes an inner dimension along at least one axis arranged perpendicular to the axial direction of the muffle housing that is greater than that of the corresponding flow control insert at the same axial position to result in the expansion of the muffler housing along the expansion chamber thereof in comparison to the flow area through the corresponding flow control insert. Any such combination of tubular configurations of the muffle housing and the flow control insert that result in the resulting refrigerant muffler having the same beneficial features as described herein may be utilized while remaining within the scope of the present invention.

The relationships present between the muffler housing and the corresponding flow control insert have also been described in terms of relative inner and outer diameters when referring to the axially symmetric shapes shown and described herein. It should be readily appreciated that if an alternative tubular configuration is utilized, the described diameters of the muffler housing and the flow control insert may refer to any dimension of the tubular configuration arranged perpendicular to the axial direction of the refrigerant muffler for establishing the relationships described herein wherein the flow control insert defines a smaller flow area than the expansion chamber of the muffler housing along at least a portion of a length of the expansion chamber.

The flow control insert has also generally be depicted as extending across the entirety of the axial extension of the corresponding expansion chamber from the inlet to outlet thereof. However, it should be understood that a relatively small axial gap may be present between one or both of the axial ends of the flow control insert and the corresponding inner circumferential surface of the muffler housing while still achieving the same beneficial properties of the present invention. That is, the axial gap may be provided to include an axial length that is small enough that the refrigerant does not tend to expand axially into the resulting annular space formed around the corresponding inlet or outlet of the expansion chamber, but is instead directed primarily along the corresponding flow pathway for substantially rectilinear passage through the refrigerant muffler. Such an example of a relatively small axial gap is depicted at the axial ends of the flow control insert 550 of FIG. 9, wherein the axial gaps are small enough to prevent undesirable expansion and contraction of the refrigerant due to the refrigerant having a more energy-efficient flow path when flowing directly into the flow pathway 555 defined by the flow control insert 550 in a substantially rectilinear flow direction.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A flow control insert configured for installation into a muffler housing receiving a flow of a fluid therethrough, the muffler housing having an expansion chamber formed therein with the expansion chamber defined by a housing inner circumferential surface of the muffler housing, the flow control insert comprising:
a tubular insert circumferential wall having an insert inner circumferential surface defining a flow pathway through the flow control insert from a first end to a second of the insert circumferential wall with respect to an axial direction thereof, the flow pathway extending axially across at least a portion of the expansion chamber of the muffler housing when the flow control insert is installed therein, wherein an inner diameter of the insert inner circumferential surface is less than an inner diameter of the at least a portion of the expansion chamber, wherein the insert inner circumferential surface delimits radially outward expansion of the fluid when the fluid is passing through the flow pathway along the at least a portion of the expansion chamber, and wherein at least a section of the insert circumferential wall disposed along the expansion chamber is porous to provide acoustic wave communication between the flow pathway and the housing inner circumferential surface along the at least a portion of the expansion chamber.

2. The flow control insert of claim 1, wherein a porosity of the at least a section of the insert circumferential wall is between 10-25% when the corresponding pores are provided as through-holes of the insert circumferential wall.

3. The flow control insert of claim 1, wherein the pores of the at least a section of the insert circumferential wall are at least 900 μm in diameter when the corresponding pores are not provided as through-holes of the insert circumferential wall.

4. The flow control insert of claim 1, wherein a porosity of the at least a section of the insert circumferential wall is selected to prevent the at least a section of the insert circumferential wall from operating as a Helmholtz resonator.

5. The flow control insert of claim 1, wherein the at least a section of the insert circumferential wall is formed by a screen having a plurality of pores formed as through-holes of the insert circumferential wall.

6. The flow control insert of claim 5, wherein the screen is provided as a non-woven polymer screen.

7. The flow control insert of claim 1, wherein the at least a section of the insert circumferential wall is formed from a sintered metal or a sintered polymer.

8. The flow control insert of claim 7, wherein at least a section of the insert circumferential wall is formed by a plurality of axially stacked disc elements formed from the sintered metal or the sintered polymer.

9. The flow control insert of claim 8, wherein each of the disc elements includes a central opening defining a portion of the flow pathway through the flow control insert.

10. The flow control insert of claim 1, wherein the insert inner circumferential surface defines a Venturi passageway within the flow pathway adjacent an inlet into the expansion chamber of the muffler housing when the flow control insert is installed therein.

11. The flow control insert of claim 10, wherein the insert inner circumferential surface defines a Venturi passageway within the flow pathway adjacent an outlet from the expansion chamber of the muffler housing when the flow control insert is installed therein.

12. The flow control insert of claim 1, further comprising a first retaining projection adjacent the first end of the insert circumferential wall and a second retaining projection adjacent the second end of the insert circumferential wall, wherein each of the first retaining projection and the second retaining projection engage the housing inner circumferential surface of the muffler housing when the flow control insert is installed within the muffler housing.

13. The flow control insert of claim 1, wherein the at least a section of the insert circumferential wall is spaced axially from an inlet into the expansion chamber of the muffler housing when the flow control insert is disposed.

14. The flow control insert of claim 1, wherein an inner diameter of the insert inner circumferential surface is 90-125% of an inner diameter of an inlet into the expansion chamber of the muffler housing.

15. A refrigerant muffler configured to convey a flow of refrigerant therethrough, the refrigerant muffler comprising:
a muffler housing having a housing inner circumferential surface defining an expansion chamber, an inlet into the expansion chamber, and an outlet from the expansion chamber; and
a flow control insert disposed within the muffler housing, the flow control insert including a tubular insert circumferential wall having an insert inner circumferential surface defining a flow pathway through the flow control insert from a first end to a second of the insert circumferential wall with respect to an axial direction thereof, the flow pathway extending axially across at least a portion of the expansion chamber of the muffler housing when the flow control insert is installed therein, wherein an inner diameter of the insert inner circumferential surface is less than an inner diameter of the at least a portion of the expansion chamber, wherein the insert inner circumferential surface delimits radially outward expansion of the refrigerant when the refrigerant is passing through the flow pathway along the at least a portion of the expansion chamber in a direction from the inlet to the outlet of the expansion chamber, and wherein at least a section of the insert circumferential wall disposed along the expansion chamber is porous to provide acoustic wave communication between the flow pathway and the housing inner circumferential surface along the at least a portion of the expansion chamber.

16. The refrigerant muffler of claim 15, wherein the housing inner circumferential surface further defines an inlet chamber of the muffler housing having a Venturi passageway formed therein adjacent the inlet to the expansion chamber and an outlet chamber of the muffler housing having a Venturi passageway formed therein adjacent the outlet from the expansion chamber.

17. The refrigerant muffler of claim 15, wherein a porosity of the at least a section of the insert circumferential wall is between 10-25% when the corresponding pores are provided as through-holes of the insert circumferential wall, and wherein the at least a section of the insert circumferential wall is 1 mm or less in radial thickness.

18. The refrigerant muffler of claim 15, wherein the pores of the at least a section of the insert circumferential wall are at least 900 μm in diameter when the corresponding pores are not provided as through-holes of the insert circumferential wall, and wherein the at least a section of the insert circumferential wall is greater than 1 mm in radial thickness.

19. The refrigerant muffler of claim 15, wherein a porosity of the at least a section of the insert circumferential wall is selected to prevent the at least a section of the insert circumferential wall from operating as a Helmholtz resonator.

20. The refrigerant muffler of claim 15, wherein a porosity of the at least a section of the insert circumferential wall is selected to prevent the formation of a recirculation zone of the refrigerant within an annular space disposed radially outwardly of the insert circumferential wall.
